(19) United States
(12) Patent Application Publication
(10) Pub. No.: US 2025/0062367 A1
(43) Pub. Date: Feb. 20, 2025

(54) PROCESSES FOR FORMING CARBON-SUPPORTED PLATINUM NANOCRYSTALS OF DIFFERENT MORPHOLOGIES

(71) Applicant: Honda Motor Co., Ltd., Tokyo (JP)

(72) Inventors: Haibin WU, Santa Clara, CA (US); Shutang CHEN, Livermore, CA (US); Gugang CHEN, Palo Alto, CA (US)

(21) Appl. No.: 18/233,785

(22) Filed: Aug. 14, 2023

(51) Int. Cl. H01M 4/92; H01M 4/88

(52) U.S. Cl. CPC H01M 4/926; H01M 4/88

(57) ABSTRACT

Aspects of the present disclosure generally relate to processes for forming carbon-supported platinum nanocrystals. In an aspect is provided a process for forming a carbon-supported platinum catalyst that includes forming a mixture comprising a platinum metal source, a carbon source, an acid, and a solvent. The process further includes heating the mixture at a temperature that is from about 80° C. to about 250° C. to form a carbon-supported platinum nanocatalyst, the carbon-supported platinum nanocatalyst comprising platinum nanoparticles chemically bonded to a carbon support.

### FIELD

Aspects of the present disclosure generally relate to processes for forming carbon-supported platinum nanocrystals.

### BACKGROUND

Platinum (Pt) and its alloys are widely used as fuel cell electrode materials due to their exceptional catalytic performance. While platinum-nickel and other binary Pt-based alternatives demonstrate improved activity compared to typical catalysts, their limited durability and limited chemical resistance to corrosion constrains their application as fuel cell electrode materials in corrosive electrolytes. Recent studies have established a close relationship between the shape/morphology of Pt catalysts and their catalytic activity. Accordingly, there is a need for achieving particular morphologies of Pt-based catalysts for use in fuel cells. In addition, loading Pt catalysts onto carbon support materials is a technique for enhancing the catalytic activity of Pt catalysts. However, conventional loading methods are unable to produce a firm contact between Pt catalysts and carbon, and consequently, the long-term stability and operational durability of Pt-carbon catalysts in fuel cells decreases.

There is a need for new and improved processes for forming carbon-supported platinum nanocrystals. There is also a need for new and improved processes for forming platinum nanocrystals of different morphologies. There is also a need for new and improved processes for chemically grafting platinum nanocrystals onto carbon supports.

### SUMMARY

Aspects of the present disclosure generally relate to processes for forming carbon-supported platinum nanocrystals. The nanocrystals (also called nanocatalysts) can be in the form of nanoparticles. Unlike conventional technologies that easily dissolve into an electrolyte solution or drop off from carbon supports, carbon-supported Pt nanocatalysts formed by aspects described herein are stable due to, for example, chemical bonding between the nanocatalysts and the carbon support. Further, and unlike conventional technologies, processes described herein can enable a tailored synthesis of various Pt morphologies by, for example, adjusting reaction temperature, the heating procedure (for example, a one-step heating process or a multi-step heating process), or combinations thereof. This is in contrast to conventional technologies that utilize ligands and/or surfactants to control Pt morphology. Pt catalysts described herein can have increased long-term durability, increased long-term operational stability, and improved catalyst activity relative to conventional Pt catalysts.

In an aspect, a process for forming a carbon-supported platinum catalyst is provided. The process includes forming a mixture that includes a platinum metal source, a carbon source, an acid, and a solvent. The process further includes heating the mixture at a temperature that is from about 80° C. to about 250° C. to form a carbon-supported platinum nanocatalyst, the carbon-supported platinum nanocatalyst including platinum nanoparticles chemically bonded to a carbon support.

In another aspect, a process for forming platinum nanocrystals of a selected morphology on a carbon support is provided. The process includes forming a mixture that includes a platinum metal source, a carbon source, an acid, and a solvent. The process further includes heating the mixture at a temperature within a single temperature range inclusive for a selected period of time to form a carbon-supported platinum nanocatalyst, wherein the carbon-supported platinum nanocatalyst includes platinum nanocrystals chemically bonded to a carbon support, and the platinum nanocrystals are in the form of nanocubes or irregular nanospheres.

In another aspect, a process for forming platinum nanocrystals on a carbon support is provided. The process includes reacting, under reaction conditions, a mixture that includes a platinum metal source, a carbon source, an acid, and a solvent to form a carbon-supported platinum nanocatalyst. The carbon-supported platinum nanocatalyst includes platinum tetrahedra nanocrystals chemically bonded to the carbon support, and the carbon source includes a structure having graphitic bonds partially incorporating oxygen atoms. The reaction conditions include heating the mixture at a first temperature or first temperature range for a first period, then heating the mixture at a second temperature or second temperature range for a second period, and then heating the mixture at a third temperature or third temperature range for a third period, wherein at least two of the first temperature or range, the second temperature or range, and the third temperature or range are different.

In another aspect, a process for controlling the morphology of platinum nanocrystals on a carbon support is provided. The process includes forming a mixture that includes a platinum metal source, a carbon source, an acid, and a solvent. The process further includes placing the mixture at an operating pressure. The process further includes performing a heating process on the mixture. The heating process can include heating the mixture at a temperature within a single temperature range of about 80° C. to about 120° C. to form carbon-supported platinum nanocrystals that includes platinum irregular nanospheres chemically bonded to the carbon support. The heating process can include heating the mixture at a temperature within a single temperature range of about 150° C. to about 210° C. to form carbon-supported platinum nanocrystals that includes platinum nanocubes chemically bonded to the carbon support. The heating process can include heating the mixture by a multi-step heating process that includes heating the mixture at a first temperature that is from 50° C. to less than 110° C., then heating the mixture at a second temperature that is from 110° C. to less than 170° C., and then heating the mixture at a third temperature that is from 170° C. to 250° C. or less to form carbon-supported platinum nanocrystals that includes platinum tetrahedra chemically bonded to the carbon support.

### BRIEF DESCRIPTION OF THE DRAWINGS

So that the manner in which the above recited features of the present disclosure can be understood in detail, a more particular description of the disclosure, briefly summarized above, may be had by reference to aspects, some of which are illustrated in the appended drawings. It is to be noted, however, that the appended drawings illustrate only exemplary aspects and are therefore not to be considered limiting of its scope, for the disclosure may admit to other equally effective aspects.

FIGS. 1A-1E show exemplary, but non-limiting, transmission electron microscopy (TEM) images of example platinum (Pt) nanocatalysts made by an example one-step heating process at different temperatures according to at least one aspect of the present disclosure.

FIGS. 2A-2D show exemplary, but non-limiting, TEM images of example Pt nanocatalysts formed during an example multi-step heating process at different temperatures according to at least one aspect of the present disclosure.

FIG. 3 shows exemplary, but non-limiting, X-ray diffraction (XRD) patterns of example Pt nanocatalysts synthesized at various temperatures—80° C., 100° C., 150° C., and 210° C.—according to at least one aspect of the present disclosure.

FIG. 4A shows exemplary, but non-limiting, cyclic voltammetry (CV) curves of example Pt nanocubes on reduced graphene oxide (rGO) according to at least one aspect of the present disclosure.

FIG. 4B shows exemplary, but non-limiting, linear sweep voltammetry (LSV) curves of example Pt nanocubes on rGO according to at least one aspect of the present disclosure.

FIG. 4C shows exemplary, but non-limiting, kinetic current data for example Pt nanocubes on rGO according to at least one aspect of the present disclosure.

### DETAILED DESCRIPTION

Aspects of the present disclosure generally relate to processes for forming carbon-supported platinum nanocrystals. The inventors have found processes that can be used to form carbon-supported platinum nanocrystals of selected morphology. Unlike conventional technologies, processes described herein can also enable formation of a chemical bond between the carbon support and the platinum nanocrystals. Further, the carbon-supported platinum nanocrystals can have better performance than conventional carbon-supported catalysts in terms of, for example, durability, stability, and catalyst activity.

The use of headings is for purposes of convenience only and does not limit the scope of the present disclosure. Aspects described herein can be combined with other aspects.

As used herein, a “composition” can include component(s) of the composition, reaction product(s) of two or more components of the composition, and/or a remainder balance of remaining starting component(s). Compositions of the present disclosure can be prepared by any suitable mixing process.

As described above, increased energy use and climate change concerns have spurred the rapid development of technology with low or even zero carbon emissions. One such technology is hydrogen fuel cells. Hydrogen fuel cells are highly efficient energy conversion technologies now used in a variety of vehicles, including automobiles, trucks, and future ocean-going freighters and aircraft. However, there is a pressing need to improve fuel cell technologies to meet energy demands, specifically by reducing Pt usage and maintaining high performance over the long term.

The primary catalysts used in fuel cells are Pt and its alloys. Such catalysts are utilized in fuel cells to enhance the conversion of raw materials to energy via direct electrochemical oxygen reduction reactions and hydrogen evolution reactions. Although Pt alloys have been developed over the past two decades, pure Pt catalysts continue to play a substantial role in fuel cell applications as both cathode and anode materials.

Recent studies have established a close relationship between the shape/morphology of Pt catalysts and their catalytic activity. Studies have also shown that cathodic reaction activity is highly dependent on crystal facets. Because different nanomaterial morphologies can exhibit different dominant crystal facets, control over the morphology can be an important factor in the synthesis of Pt catalysts. Accordingly, there is a need for achieving specific morphologies of Pt-based catalysts for use in fuel cells.

In addition, Pt-based catalyst applications utilize nanosized Pt catalysts that are loaded onto carbon supports. Such supported Pt catalysts can efficiently enhance performance by reducing agglomeration. However, conventional technologies for loading Pt onto supports are hindered by catalyst detachment, carbon corrosion, catalyst agglomeration, and catalyst dissolution. These issues result in, for example, the rapid performance decline in long-term durability tests. With respect to detachment and dissolution, conventional loading methods are unable to produce a firm contact between Pt catalysts and carbon. Without a good, firm contact between the Pt catalysts and the carbon support, the long-term stability and operational durability of Pt-carbon in fuel cells decreases. For example, conventional Pt-based catalysts can easily dissolve into solution (such as acid solutions) or the metal drops off from the carbon support. That is, conventional technologies lack stable bonds between the Pt catalysts and the carbon support, and the art lacks a consistent method to stabilize Pt catalysts on carbon supports through chemical bonding. As another example, conventional Pt catalysts can only physically adsorb onto carbon materials using the available loading methods. In addition, typical carbon supports (for example, Vulcan XC-72) are spherical, further impairing the interaction between catalysts and carbon structures.

In view of the foregoing challenges and problems, the inventors have discovered processes for synthesizing various morphologies of Pt nanoparticles that show, for example, significantly improved long-term stability, operational durability, and catalytic activity relative to conventional Pt/C catalysts. In some aspects, processes described herein include a one-pot reaction. The one-pot reaction can be a solvothermal reaction. Relative to conventional methods of forming Pt/C, processes described herein are simple and efficient. In some aspects, and unlike conventional technologies, processes of the present disclosure can also enable formation of a specific morphology of Pt nanoparticles (for example, tetrahedron, nanocube, irregular nanosphere, and nanorod, among others) on a carbon support such as a graphene derivative (for example, reduced graphene oxide).

In some aspects, the inventors found that controlling the morphology of the Pt nanocrystals can include, for example, selecting a heating temperature, a heating procedure (for example, a one-step heating process or a multi-step heating process), or combinations thereof, among other parameters within a particular synthetic system. Chemically growing shape-controlled Pt catalysts onto a flat carbon support (such as graphene oxide or reduced graphene oxide) can help address issues related to the interaction between catalysts and carbon structures. The inventors also found that the types of Pt nanostructures can exhibit different performance in fuel cell reactions. As a non-limiting example, carbon-supported Pt nanocubes as formed by processes described herein show improved performance in oxygen reduction reactions (ORR). In some aspects, the carbon-supported supported Pt nanostructures can be surface cleaned prior to reaction in a fuel cell. Overall, processes described herein can be utilized to, for example, form carbon-supported Pt nanostructures having improved performance in ORR and/or other fuel cell reactions relative to conventional technologies.

Carbon-supported platinum nanoparticles of various morphologies (such as tetrahedron, nanocube, nanosphere, and nanorod, among others) are described herein. Carbon supports can include graphene derivatives (for example, graphene oxide and reduced graphene oxide) and can have various functional groups that can allow interactions (such as chemical bonding, physical bonding, or both) to metals. The carbon-supported Pt nanoparticles described herein can include Pt structures chemically bonded to the surface of a carbon support. The chemical bonding between the nanocatalysts (the Pt structures) and the carbon support can be through carboxyl groups (—COOH), hydroxyl groups (—OH), carbonyl groups (C═O), epoxide groups, and/or ions thereof (for example, —COO⁻ and/or —O⁻) present on the carbon support and the Pt nanoparticles. For example, graphene oxide such as reduced graphene oxide contains one or more of such groups which can chemically bond to the Pt nanocatalysts.

### Processes

Aspects of the present disclosure generally relate to processes for forming carbon-supported platinum nanocrystals. Processes described herein can enable the formation of various morphologies of Pt nanoparticles (for example, for example, tetrahedron, nanocube, nanosphere, and nanorod, among others) on the carbon support. In some aspects, synthetic strategies described herein utilize a one-pot solvothermal process, thereby simplifying the synthetic process for forming Pt catalysts on carbon supports. In some aspects, the process can utilize a conventional heating oven as opposed to microwave ovens and/or ultrasonic assistance typical of conventional technologies. In some aspects, and in contrast to conventional methods which utilize harsh heating conditions, heating temperatures utilized during processes described herein can be milder. For example, heating temperatures can range from about 50° C. or more, such as about 65° C., such as from about 80° C. to about 250° C., such as from about 80° C. to about 220° C. In addition, aspects described herein can enable control over the shape (morphology) by adjusting the heating temperature, the heating procedure (for example, a one-step heating process or a multi-step heating process), or combinations thereof, among other parameters within a particular synthetic system. Of note, processes described herein can control the Pt shape directly on the carbon support by adjusting the heating temperature, the heating procedure (for example, a one-step heating process or a multi-step heating process), or combinations thereof, which differs from conventional shape-controlled synthesis methods.

In some aspects, the process for forming the carbon-supported Pt nanocrystals can be a solvothermal synthesis. Solvothermal synthesis is a chemical reaction that takes place in a solvent at relatively high temperatures. The reactor for solvothermal syntheses can be a sealed vessel.

In some aspects, the process can include forming a mixture that includes a Pt metal source, a carbon source, an acid, and a solvent. The mixture can be formed in any suitable reactor such as a tubular reactor or an autoclave reactor. Prior to heating (described below), the mixture can be stirred, mixed, and/or agitated to ensure e.g., homogeneity of the mixture. In at least one aspect, and prior to heating, the mixture of components can be placed under a non-reactive gas such as nitrogen (N₂), argon (Ar), and/or other non-reactive gas(es) to degas various components or otherwise remove oxygen from the reaction mixture and/or mixing environment.

Unlike conventional methods of forming carbon-supported Pt nanocatalysts which utilize surfactants and/or ligands, aspects described herein can be free of surfactants and ligands. For example, conventional methods utilize surfactants such as polyvinylpyrrolidone, citric acid, and cetyltrimethylammonium bromide, and/or ligands such as trioctylphosphine, oleic acid, and oleyl amine. Conventional methods utilize ambient pressure and the morphology of the Pt nanoparticles are highly dependent on the applications of ligands or surfactants. That is, various shapes of nanocrystals are achieved by conventional technologies only by use of ligands and/or surfactants. In contrast, the carbon-supported Pt nanocatalysts described herein can be formed without the use of surfactants and ligands. For example, the mixture that includes a Pt metal source, a carbon source, an acid, and a solvent can be free of surfactants and ligands. In further contrast to conventional methods, aspects described herein all the adjustment of temperature, the selection of the heating process, or combinations thereof to control nanoparticle morphology

The process further includes heating the mixture to form carbon-supported platinum nanoparticle(s). For heating, the reactor can be placed on or in any suitable heating device such as a heating oven. If desired, a microwave oven can be utilized. Heating can be performed in the form of a one-step heating process or a multi-step heating process. One-step heating process refers to heating the mixture at a selected reaction temperature for a selected period. Multi-step heating process refers to heating the mixture at multiple different reaction temperatures, each at a selected amount of time. The one-step heating process and multi-step heating process are described further below.

Any suitable platinum metal source can be utilized. The Pt metal source can include one or more ligands such as halide (I⁻, Br⁻, Cl⁻, or F⁻), acetylacetonate (O₂C₅H₇⁻), hydride (H⁻), SCN⁻, NO₂⁻, NO₃⁻, N₃⁻, OH⁻, oxalate (C₂O₄²⁻), H₂O, acetate (CH₃COO⁻), O₂⁻, CN⁻, OCN⁻, OCN⁻, CNO⁻, NH₂⁻, NH²⁻, NC⁻, NCS⁻, N(CN)₂⁻, pyridine (py), ethylenediamine (en), 2,2′-bipyridine (bipy), PPh₃, or combinations thereof. In some aspects, the Pt metal source can include platinum acetylacetonates, platinum acetates, platinum halides, platinum nitrates, and/or other suitable platinum species. Hydrates are also contemplated.

Illustrative, but non-limiting, examples of Pt metal sources can include platinum(II) acetylacetonate (Pt(C₅H₇O₂)₂ also referred to as Pt(acac)₂), hexachloroplatinic acid (or hydrates thereof, for example, H₂PtCl₆.6H₂O), platinum chloride (PtCl₄), potassium platinum(II) chloride (K₂PtCl₄), platinum(II) acetate (Pt(CH₃CO₂)₂), platinum(IV) acetate (Pt(CH₃CO₂)₄), sodium hexachloroplatinate hexahydrate (Na₂PtCl₆.6H₂O), or combinations thereof, among others.

Any suitable carbon source can be utilized for the carbon support. In some examples, the carbon source includes a graphene derivative. Graphene derivatives, as described herein, include structures having graphitic bonds partially incorporating heteroatoms such as oxygen or other structural imperfections in the carbon lattice. Graphene derivatives, as described herein, also include structures such as nanotubes, nanobuds, fullerenes, nano-peapods, endofullerenes, nano-onions, graphene oxide, reduced graphene oxide, lacey carbon, and other non-graphene forms of graphitic carbon which may contain structural or chemical imperfections. Combinations of graphene derivatives can be utilized. In some aspects, the graphene derivative comprises graphene oxide, reduced graphene oxide, or combinations thereof.

A weight ratio of Pt metal source to carbon source can be from about 5:1 to about 1:10, such as from about 4:1 to about 1:8, such as from about 3:1 to about 1:5, or from about 2:1 to about 2:3, or from about 1:1 to about 1:2, such as about 1:1, about 2:1, or about 2:3, though other weight ratios are contemplated. Any of the foregoing numbers can be used singly to describe an open-ended range or in combination to describe a close-ended range.

Any suitable acid can be utilized. In some examples, the acid can include an organic acid, an inorganic acid, or combinations thereof. Illustrative, but non-limiting, examples of acids can include formic acid, acetic acid, carbonic acid, propionic acid, sulfuric acid (H₂SO₄), phosphoric acid (H₃PO₄), nitric acid (HNO₃), perchloric acid (HClO₄), hydrochloric acid (HCl), or combinations thereof.

The acid may be provided as a solution, for example, an aqueous solution. In some aspects, the concentration of acid in the aqueous solution is from about 0.1 M to about 2 M, such as from about 0.5 M to about 1.5 M, such as from about 1 M to about 1.25 M. Any of the foregoing numbers can be used singly to describe an open-ended range or in combination to describe a close-ended range. Additionally, or alternatively, an aldehyde such as formaldehyde can be utilized in addition to the acid or to replace the acid. The concentration of the aldehyde in the aqueous solution can be similar to those concentrations described for the acid.

A molar ratio of Pt metal source to acid can be from about 1:500 to about 1:1, such as from about 1:200 to about 1:1, such as from about 1:50 to about 1:1, such as from about 1:20 to about 1:1, such as from about 1:10 to about 1:5 based on the starting material molar ratio used for the reaction. Any of the foregoing numbers can be used singly to describe an open-ended range or in combination to describe a close-ended range. In some aspects, the molar ratio of Pt metal source to acid can be from about 1:10 to about 1:1, from about 1:10 to about 1:5, from about 1:5 to about 1:1, from about 1:2 to about 1:1 based on the starting material molar ratio used for the reaction. Any of the foregoing numbers can be used singly to describe an open-ended range or in combination to describe a close-ended range.

Any suitable solvent can be utilized. In some aspects, the solvent can be selected based on the reaction temperature selected. Monohydric alcohols solvents (solvents containing one alcohol functional group), polyhydric alcohols (solvents containing two or more alcohol functional groups), or combinations thereof can be utilized as solvents. Polyhydric alcohols are referred to as glycols. Non-limiting examples of polyhydric alcohols can include diols, triols, and/or other polyols such as ethylene glycol, tetraethylene glycol, propylene glycol, glycerol (also called glycerin), or combinations thereof, among others.

Illustrative, but non-limiting, of monohydric alcohol that can be utilized as a solvent include ethylene glycol, propylene glycol, glycerol (also called glycerin), n-propanol, iso-propanol, n-butanol, t-butanol, sec-butanol, tert-butanol, pentanol, hexanol, heptanol, octanol, ethyl-2-hexanol, isooctanol, nonanol, n-decanol, isodecanol, undecanol, dodecanol, tridecanol, tetradecanol, pentadecanol, hexadecanol, heptadecanol, octadecanol, nonadecanol, icosanol, heneicosanol, docosanol, tricosanol, tetracosanol, pentacosanol, hexacosanol, heptacosanol, octacosanol, nonacosanol, or isomers thereof. Alcohol and glycolic solvents containing aromatic rings are also contemplated such as phenols or alcohols containing aromatic groups, such as cardanol, resorcinol, cresol, phenol, bisphenol, or combinations thereof, among others can be utilized. Combinations of solvents in any suitable proportions can be utilized.

In at least one aspect, the solvent can comprise, or be selected from the group consisting of, ethylene glycol, tetraethylene glycol, propylene glycol, glycerol, or combinations thereof.

In some aspects, the Pt metal source and the solvent can be mixed prior to addition of the remaining materials (e.g., the carbon source and the acid). For example, the Pt metal source and solvent can be mixed by any suitable method such as by stirring, sonicating, and/or agitating. Optionally, the Pt metal source can be mixed under the presence of a non-reactive gas such as N₂, Ar, and/or other non-reactive gas(es) to degas various components or otherwise remove oxygen from the reaction mixture. Any reasonable pressure can be used mixing of the Pt metal source and the solvent. Other components, for example, the carbon source and acid can then be added. The resulting mixture can then be mixed as described above. The mixture can then be subjected to the heating process.

Referring back to the different heating processes (the one-step heating process and the multi-step heating process), selection of the heating process can enable selection of the morphology of the Pt nanocrystals. The mixture subjected to the heating process can comprise, consist essentially of, or consist of a Pt metal source, a carbon source, an acid, and a solvent. As described above, the mixture can be formed in any suitable reactor (such as an autoclave reactor) and the reactor can then be placed in any suitable heating apparatus (such as a heating oven).

### Example One—Step Heating Process

In some aspects, the mixture including the Pt metal source, carbon source, acid, and solvent is reacted by performing by a one-step heating process. The one-step heating process can include heating the mixture at a selected temperature or selected temperature range for a selected amount of time (period). The selected temperature or selected temperature range is a single temperature or single temperature range at which one or more components of the mixture react. The selected temperature or selected temperature range can include the endpoints of the range. The one-step heating process can consist essentially of, or consist of heating the mixture at a single selected temperature or single selected temperature range.

In at least one aspect, the single temperature or single temperature range can be from about 50° C. to about 250° C., such as from about 65° C. to about 245° C., such as from about 80° C. to about 220° C., such as from about 90° C. to about 210° C., such as from about 100° C. to about 200° C., such as from about 110° C. to about 190° C., such as from about 120° C. to about 180° C., such as from about 130° C. to about 170° C., such as from about 140° C. to about 170° C., such as from about 150° C. to about 160° C., though other values are contemplated. Any of the foregoing numbers can be used singly to describe an open-ended range or in combination to describe a close-ended range.

In some aspects, choice of heating the mixture by a one-step heating process can result in the formation of carbon-supported Pt nanocatalysts that includes Pt nanospheres chemically bonded to the carbon support. In some aspects, the single temperature or single temperature range to form Pt nanospheres chemically bonded to the carbon support can be from about 80° C. to about 120° C., such as from about 85° C. to about 115° C., such as from about 90° C. to about 110° C., such as from about 95° C. to about 105° C., such as about 100° C., though other values are contemplated. Any of the foregoing numbers can be used singly to describe an open-ended range or in combination to describe a close-ended range. The Pt nanospheres can be spherical in shape, such irregular spheres. In some aspects, and at these temperatures or temperature ranges, a majority (greater than 50%) of the Pt nanocrystals can be nanospheres. Irregular spheres refer to spherical particles that are not perfect spheres.

An amount of Pt nanoparticles/nanocrystals that are irregular in shape (irregular spheres) can be greater than 50% based on the total amount of Pt nanoparticles/nanocrystals, such as about 55% or more, such as about 60% or more, such as about 65% or more, such as about 70% or more, such as about 75% or more, such as about 80% or more, such as about 85% or more, such as about 90% or more, such as about 95% or more, though other values are contemplated. The total amount of Pt nanoparticles/nanocrystals is 100% and is based on the total amount of irregular spheres, tetrahedra (both tetrahedral-shaped and triangular-shaped), cubes, and rods.

In some aspects, choice of heating the mixture by a one-step heating process can result in the formation of carbon-supported Pt nanocatalysts that includes Pt nanocubes chemically bonded to the carbon support. In some aspects, the single temperature or single temperature range to form Pt nanocubes chemically bonded to the carbon support can be from about 150° C. to about 210° C., such as from about 155° C. to about 205° C., such as from about 160° C. to about 200° C., such as from about 165° C. to about 195° C., such as from about 170° C. to about 190° C., such as from about 175° C. to about 185° C., such as about 180° C. or about 185° C., or from about 170° C. to about 195° C., such as from about 175° C. to about 190° C., such as from about 180° C. to about 185° C., though other values are contemplated. Any of the foregoing numbers can be used singly to describe an open-ended range or in combination to describe a close-ended range. In In some aspects, and at these temperatures or temperature ranges, a majority (greater than 50%) of the Pt nanocrystals can be cubes.

An amount of Pt nanoparticles/nanocrystals that are cubes can be greater than 50% based on the total amount of Pt nanoparticles/nanocrystals, such as about 55% or more, such as about 60% or more, such as about 65% or more, such as about 70% or more, such as about 75% or more, such as about 80% or more, such as about 85% or more, such as about 90% or more, such as about 95% or more, though other values are contemplated. The total amount of Pt nanoparticles/nanocrystals is 100% and is based on the total amount of irregular spheres, tetrahedra (both tetrahedral-shaped and triangular-shaped), cubes, and rods.

The time (or period) for heating the mixture during the one-step heating process can be about 6 hours to about 48 hours, such as from about 12 hours to about 42 hours, such as from about 18 hours to about 36 hours, such as from about 24 hours to about 30 hours, though greater or lesser periods of time are contemplated. Conditions for the one-step heating process can optionally include stirring, mixing, and/or agitating the mixture to ensure, e.g., homogeneity of the mixture. In at least one aspect, conditions for the one-step heating process are free of stirring, mixing, and/or agitating during the heating process.

Conditions for the one-step heating process can optionally include using a non-reactive gas (e.g., N₂ and/or Ar) to, e.g., remove or substantially remove oxygen from the mixing environment. Suitable operating pressures can be utilized for the one-step heating process. In some examples, the operating pressure can be from about 1 bar (about 0.1 MPa) to about 2.4 bar (0.24 MPa), such as from about 1.2 bar (about 0.12 MPa) to about 2.2 bar (about 0.22 MPa), such as from about 1.4 bar (about 0.14 MPa) to about 2 bar (about 0.2 MPa), such as from about 1.6 bar (about 0.16 MPa) to about 1.8 bar (about 0.18 MPa), though other values are contemplated. Any of the foregoing numbers can be used singly to describe an open-ended range or in combination to describe a close-ended range.

Following the one-step heating process, the mixture can be allowed to cool to room temperature. A result of the one-step heating process is the formation of carbon-supported Pt nanocatalyst comprising Pt nanocrystals chemically bonded to the carbon support. The Pt nanocrystals can have those morphologies described above, for example, irregular spheres or cubes depending on the selected heating temperature or heating temperature range.

### Example Multi-Step Heating Process Multi-Step Heating Process

In some aspects, the mixture including the Pt metal source, carbon source, acid, and solvent is reacted by performing a multi-step heating process. The multi-step heating process can include heating the mixture at more than one selected temperature or more than one selected temperature range, each selected temperature or selected temperature range having a selected amount of time (period). For example, the multi-step heating process can include heating the mixture at a first temperature or a first temperature range for a first period, then heating the mixture at a second temperature or a second temperature range for a second period, then heating the mixture at a third temperature or a third temperature range for a third period, and so forth. At least two of the selected temperatures or selected temperature ranges are different.

The selected temperatures or selected temperatures ranges during the multi-step heating process are temperatures or temperature at which one or more components of the mixture react. The selected temperatures or selected temperatures ranges during the multi-step heating process can include the endpoints of the range.

In some aspects, choice of heating the mixture by a multi-step heating process can result in the formation of carbon-supported Pt nanocatalysts that includes Pt tetrahedra chemically bonded to the carbon support. In some aspects, the Pt tetrahedra can have a triangular shape, or tetrahedron shape, or combinations thereof.

After placing in the oven (which can be pre-heated), the mixture can be heated at a first temperature or first temperature range for a first period. In some aspects, the first temperature or first temperature range can be about 50° C. or more, less than 110° C., or combinations thereof, such as from about 55° C. to about 105° C., such as from about 60° C. to about 100° C., such as from about 65° C. to about 95° C., such as from about 70° C. to about 90° C., such as from about 75° C. to about 85° C., such as about 80° C., or from about 80° C. to about 100° C., such as from about 85° C. to about 95° C., though other values are contemplated. Any of the foregoing numbers can be used singly to describe an open-ended range or in combination to describe a close-ended range. The mixture can be heated for any suitable first period such as from about 30 minutes to about 10 hours, such as from about 1 hour to about 8 hours, such as from about 2 hours to about 6 hours, such as from about 3 hours to about 4 hours, such as about 3 hours, though other periods are contemplated. Any of the foregoing numbers can be used singly to describe an open-ended range or in combination to describe a close-ended range.

After heating the mixture at the first temperature or first temperature range for the first period, the mixture is heated at a second temperature or second temperature range for a second period. In some aspects, the second temperature or second temperature range can be 110° C. or more, less than 170° C., or combinations thereof, such as from about 115° C. to about 165° C., such as from about 120° C. to about 160° C., such as from about 125° C. to about 155° C., such as from about 130° C. to about 150° C., such as from about 135° C. to about 145° C., though other values are contemplated. Any of the foregoing numbers can be used singly to describe an open-ended range or in combination to describe a close-ended range. The mixture can be heated for any suitable second period such as from about 12 hours to about 36 hours, such as from about 15 hours to about 33 hours, such as from about 18 hours to about 30 hours, such as from about 21 hours to about 27 hours, such as about 24 hours, though other periods are contemplated. Any of the foregoing numbers can be used singly to describe an open-ended range or in combination to describe a close-ended range.

After heating the mixture at the second temperature or second temperature range for the second period, the mixture is heated at a third temperature or third temperature range for a third period. In some aspects, the second temperature or second temperature range can be 170° C. or more, about 250° C. or less, or combinations thereof, such as from about 175° C. to about 245° C., such as from about 180° C. to about 240° C., such as from about 185° C. to about 235° C., such as from about 190° C. to about 230° C., such as from about 195° C. to about 225° C., such as from about 200° C. to about 220° C., such as from about 205° C. to about 215° C., such as about 210° C., or from about 190° C. to about 210° C. such as from about 195° C. to about 205° C., though other values are contemplated. Any of the foregoing numbers can be used singly to describe an open-ended range or in combination to describe a close-ended range. The mixture can be heated for any suitable third period such as from about 1 hour to about 36 hours, such as from about 6 hours to about 30 hours, such as from about 12 hours to about 24 hours, or from about 1 hour to about 15 hours, such as from about 2 hours to about 12 hours, such as from about 4 hours to about 10 hours, such as from about 6 hours to about 8 hours, such as about 6 hours, though other periods are contemplated. Any of the foregoing numbers can be used singly to describe an open-ended range or in combination to describe a close-ended range.

In some aspects, the total reaction time (heating at the selected temperatures) for the multi-step heating process can vary from about 6 hours to about 72 hours, such as from about 12 hours to about 60 hours, such as from about 18 hours to about 54 hours, such as from about 24 hours to about 48 hours, such as from about 32 hours to about 40 hours, though other periods are contemplated. Any of the foregoing numbers can be used singly to describe an open-ended range or in combination to describe a close-ended range.

Conditions for the multi-step heating process can optionally include stirring, mixing, and/or agitating the mixture to ensure, e.g., homogeneity of the mixture. In at least one aspect, conditions for the multi-step heating process are free of stirring, mixing, and/or agitating during the heating process.

Conditions for the multi-step heating process can optionally include using a non-reactive gas (e.g., N₂ and/or Ar) to, e.g., remove or substantially remove oxygen from the mixing environment. Suitable operating pressures can be utilized for the multi-step heating process. In some examples, the operating pressure can be from about 1 bar (about 0.1 MPa) to about 2.4 bar (0.24 MPa), such as from about 1.2 bar (about 0.12 MPa) to about 2.2 bar (about 0.22 MPa), such as from about 1.4 bar (about 0.14 MPa) to about 2 bar (about 0.2 MPa), such as from about 1.6 bar (about 0.16 MPa) to about 1.8 bar (about 0.18 MPa), though other values are contemplated. Any of the foregoing numbers can be used singly to describe an open-ended range or in combination to describe a close-ended range.

Following the multi-step heating process, the mixture can be allowed to cool to room temperature. A result of the multi-step heating process is the formation of carbon-supported Pt nanocatalyst comprising Pt nanocrystals chemically bonded to the carbon support. The Pt nanocrystals can be tetrahedra. Tetrahedra can include both tetrahedra-shaped and triangular shaped. In some aspects, and utilizing the multi-step temperature process, a majority (greater than 50%) of the Pt nanocrystals can be tetrahedra-shaped.

An amount of Pt nanoparticles/nanocrystals that are tetrahedra-shaped and triangular-shaped can be greater than 50% based on the total amount of Pt nanoparticles/nanocrystals, such as about 55% or more, such as about 60% or more, such as about 65% or more, such as about 70% or more, such as about 75% or more, such as about 80% or more, such as about 85% or more, such as about 90% or more, such as about 95% or more, though other values are contemplated. The total amount of Pt nanoparticles/nanocrystals is 100% and is based on the total amount of irregular spheres, tetrahedra (both tetrahedral-shaped and triangular-shaped), cubes, and rods.

While not wishing to be bound by any theory, it is believed that heating the mixture at the second temperature or second temperature range for the second period can be an important factor in achieving tetrahedra shaped nanoparticles/nanocrystals, and that heating the mixture at the third temperature or third temperature range for the third period can be an important factor in removing smaller particles via Ostwald ripening.

The following examples are put forth so as to provide those of ordinary skill in the art with a complete disclosure and description of how to make and use aspects of the present disclosure, and are not intended to limit the scope of aspects of the present disclosure. Efforts have been made to ensure accuracy with respect to numbers used (such as the amounts, dimensions) but some experimental errors and deviations should be accounted for.

### EXAMPLES

Various example, but non-limiting, catalysts according to some aspects described herein were prepared. The example catalysts were compared to a commercial platinum on carbon (Pt/C) catalyst. The comparative Pt/C catalyst represents the state-of-the-art for fuel cells and is 20 wt % Pt loading on an activated carbon support (Vulcan XC-72R).

### Materials and Measurements

### Materials

Reduced graphene oxide (rGO, 2 mg/ml solution), platinum (II) bis(acetylacetonate) (Pt(acac)₂, 99%), ethylene glycol (99%), formic acid, and sulfuric acid were purchased from Sigma-Aldrich. Commercial platinum on carbon (Pt/C, 20 wt % Pt) was purchased from Alfa Aesar. All chemicals were used as received. Milli-Q water was also used in the experiments.

### Characterization Methods

The morphologies were investigated by transmission electron microscopy (TEM). TEM images were captured using an FEI Tecnai 20 microscope with an accelerating voltage of 200 kV.

X-ray diffraction (XRD) patterns were collected using a Bruker D8 Advance X-ray diffractometer with Cu Kα radiation operated at a tube voltage of 40 kV and a current of 40 mA.

### Electrochemical Measurements

Electrochemical measurements were measured on an electrochemical workstation at room temperature (25° C.), using a three-electrode electrochemical setup with a rotating disk electrode (RDE) system. A glassy carbon working electrode (GCE, disk electrode of 5 mm inner diameter, 0.196 cm²), a graphite rod counter electrode, and a silver-silver chloride (Ag/AgCl/saturated KCl) reference electrode were used for all the tests. All potentials herein are quoted with respect to a reversible hydrogen electrode (RHE). The potential at the zero current point was chosen as the reaction potential of the hydrogen electrode. The potential at the zero current point was determined to be −0.258 V, so the potential measured with an Ag/AgCl electrode can be related by E(RHE)=E(Ag/AgCl)+0.258 V.

Prior to modifying the GCE with the Pt-rGO catalysts, the catalysts were heated in an oven under ambient conditions for 24 hours at 200° C. A commercial platinum on carbon catalyst (Pt/C, 20 wt %, Sigma-Aldrich) was used for certain examples. The electrode was prepared as follows. First, a catalyst ink was prepared by ultrasonicating a mixture of about 4 mg catalyst (the metal nanoparticles; Pt loading was about 4 μg), about 1.6 mL water, about 0.4 mL isopropanol, and about 20 μL Nafion™ solution (5 wt %, Sigma-Aldrich) for about 30 minutes to obtain a catalyst ink slurry. About 10 μL of the catalyst ink slurry was spread onto the disk electrode surface (GCE) surface using a micropipette, followed by drying under ambient conditions with a rotation speed of about 700 rpm. Thus, a working electrode was produced. Loading for all the catalyst samples was kept at about 4 μg.

Before the measurements, the catalyst-modified electrodes were fully activated by running 30-35 complete cycles in the potential range of 0.025-1.3 V (vs. RHE). This process cleaned the catalyst surfaces and removed physically adsorbed molecules, exposing the active sites to the solution. Cyclic voltammetry was first obtained to examine the electro-chemically active surface area surface area (ECSA). The CV scan was performed at a rate of 50 mV s⁻¹ in an Ar-saturated 0.1 M perchloric acid (HClO₄) solution in the potential range of 0.025-1.3 V (vs. RHE). Two and a half cycles of CV were recorded to obtain reproducible cycles. The oxygen reduction reaction (ORR) polarization curves were recorded in an O₂-saturated 0.1 M HClO₄ electrolyte at a rotation speed of 1,600 rpm and a scan rate of 10 mV s⁻¹.

### Example Syntheses of Pt Nanostructures on rGO

Various example, but non-limiting, Pt-rGO catalysts (platinum metal nanoparticles supported on reduced graphene oxide) were prepared according to some aspects described herein. In the non-limiting examples, Pt nanoparticles having tetrahedron morphology and supported on rGO, Pt nanoparticles having cube morphology and supported on rGO, and Pt nanoparticles having irregular sphere morphology and supported on rGO were individually prepared as described below. This morphology can be controlled by adjusting reaction temperature, the heating procedure (for example, a one-step heating process or a multi-step heating process), or combinations thereof. Relative to commercial and conventional Pt catalysts, the supported catalysts formed by aspects described herein can have increased long-term durability, increased long-term operational stability, and improved catalyst activity.

### Example 1: Example Synthesis of Nano Pt Tetrahedra on rGO

A step-wise heating method (multi-step heating method) was utilized for the synthesis. The synthesis method is a solvothermal approach using a 100 mL hydrothermal autoclave and a conventional oven for heating. First, Pt(acac)₂ (40 mg) was sonicated for about 10 minutes in ethylene glycol (6 mL). Then, reduced graphene oxide (2 mL), formic acid (2 mL), and sulfuric acid (0.5 M, 1 mL) were added to the sonicated Pt(acac)₂ and ethylene glycol to form a mixture. The mixture was mixed and the resulting well-mixed black suspension containing all precursors was transferred to the 100 mL autoclave reactor.

A heating oven was pre-heated to a temperature of about 80° C. The autoclave reactor containing the suspension was placed in the pre-heated oven and heated at the temperature of about 80° C. for about 3 hours. The oven temperature was then increased to about 130° C. and the contents of the autoclave reactor were reacted at this temperature for about 24 hours. Subsequently, the oven temperature was further increased to about 210° C., and the contents of the autoclave reactor were reacted at this temperature for about 6 hours.

After the step-wise heating process, the reactor was allowed to cool to about room temperature (about 20° C.) which took approximately 6 hours. To remove excess unreacted precursors, solvent, and/or other byproducts, the supernatant was decanted, and about 25 mL of isopropanol (IPA) was added. The products were sonicated for about 30 minutes in the IPA to remove adsorbed solvent molecules. The products were separated by centrifuging at about 8,000 rpm for about 20 minutes. If desired, an additional 20 minutes of centrifugation at 8,000 rpm was performed to remove adsorbed solvent molecules. The black sediment was retrieved and washed by adding IPA or water with sonication for about 30 minutes, followed by centrifugation at about 7,000 rpm for about 15 minutes. This washing procedure was repeated twice more. The precipitate from the suspension was dried in a vacuum desiccator before further characterization and application. The resulting carbon-supported Pt nanocatalysts were determined to include Pt nanocrystals that were mostly Pt tetrahedra structures chemically bonded to the rGO. The tetrahedra structures include triangular-shaped structures and tetrahedron-shaped structures.

Various parameters were also investigated. For example, the different heating temperatures can be changed. Here, the first heating operation can vary from about 60° C. to about 100° C., the second heating operation can vary from about 110° C. to about 150° C., and the third heating operation can vary from about 190° C. to about 230° C. The total reaction time (heating at the selected temperatures) can vary from about 6 hours to about 72 hours.

### Example 2: Example Synthesis of Nano Pt Cubes on rGO

A one-step heating method was utilized for the synthesis. The synthesis method is a solvothermal approach using a 100 mL hydrothermal autoclave and a conventional oven for heating. First, Pt(acac)₂ (40 mg) was sonicated for about 10 minutes in ethylene glycol (6 mL). Then, reduced graphene oxide (2 mL), formic acid (2 mL), and sulfuric acid (0.5 M, 1 mL) were added to the sonicated Pt(acac)₂ and ethylene glycol to form a mixture. The mixture was mixed and the resulting well-mixed black suspension containing all precursors was transferred to the 100 mL autoclave reactor.

A heating oven was pre-heated to a temperature of about 185° C. The autoclave reactor containing the suspension was placed in the pre-heated oven and heated at the temperature of about 185° C. for about 24 hours. After the one-step heating process, the reactor was allowed to cool to about room temperature (about 20° C.) which took approximately 6 hours.

To remove excess unreacted precursors, solvent, and/or other byproducts, the supernatant was decanted, and about 25 mL of isopropanol (IPA) was added. The products were sonicated for about 30 minutes in the IPA to remove adsorbed solvent molecules. The products were separated by centrifuging at about 8,000 rpm for about 20 minutes. If desired, an additional 20 minutes of centrifugation at 8,000 rpm was performed to remove adsorbed solvent molecules. The black sediment was retrieved and washed by adding IPA or water with sonication for about 30 minutes, followed by centrifugation at about 7,000 rpm for about 15 minutes. This washing procedure was repeated twice more. The precipitate from the suspension was dried in a vacuum desiccator before further characterization and application. The resulting carbon-supported Pt nanocatalysts were determined to include Pt nanocrystals that were mostly Pt cube structures chemically bonded to the rGO.

Various parameters were also investigated. For example, the temperature can vary from about 150° C. to about 210° C. The total reaction time (heating at the selected temperature) can vary from about 6 hours to about 48 hours. In some examples, and under the conditions tested, it was found that a temperature that is from about 170° C. to about 195° C. can provide the largest amount of nanocubes.

### Example 3: Example Synthesis of Nano Pt Irregular Spheres on rGO

A one-step heating method was utilized for the synthesis. The synthesis method is a solvothermal approach using a 100 mL hydrothermal autoclave and a conventional oven for heating. First, Pt(acac)₂ (40 mg) was sonicated for about 10 minutes in ethylene glycol (6 mL). Then, reduced graphene oxide (2 mL), formic acid (2 mL), and sulfuric acid (0.5 M, 1 mL) were added to the sonicated Pt(acac)₂ and ethylene glycol to form a mixture. The mixture was mixed and the resulting well-mixed black suspension containing all precursors was transferred to the 100mL autoclave reactor.

A heating oven was pre-heated to a temperature of about 100° C. The autoclave reactor containing the suspension was placed in the pre-heated oven and heated at the temperature of about 100° C. for about 24 hours. After the one-step heating process, the reactor was allowed to cool to about room temperature (about 20° C.) which took approximately 6 hours.

To remove excess unreacted precursors, solvent, and/or other byproducts, the supernatant was decanted, and about 25 mL of isopropanol (IPA) was added. The products were sonicated for about 30 minutes in the IPA to remove adsorbed solvent molecules. The products were separated by centrifuging at about 8,000 rpm for about 20 minutes. If desired, an additional 20 minutes of centrifugation at 8,000 rpm was performed to remove adsorbed solvent molecules. The black sediment was retrieved and washed by adding IPA or water with sonication for about 30 minutes, followed by centrifugation at about 7,000 rpm for about 15 minutes. This washing procedure was repeated twice more. The precipitate from the suspension was dried in a vacuum desiccator before further characterization and application. The resulting The resulting carbon-supported Pt nanocatalysts were determined to include Pt nanocrystals that were mostly Pt irregular sphere structures or Pt irregular sphere structures chemically bonded to the rGO.

Various parameters were also investigated. For example, the temperature can vary from about 80° C. to about 120° C. The total reaction time (heating at the selected temperature) can vary from about 6 hours to about 48 hours.

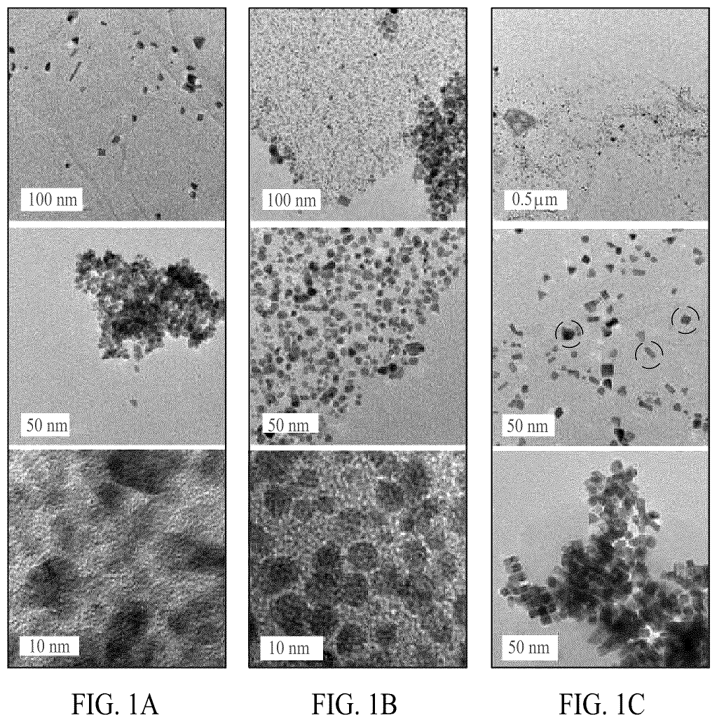

Morphology was systematically studied using TEM. FIGS. 1A-1E show TEM images of example carbon-supported platinum nanoparticles formed by the one-step heating process at different temperatures. The carbon support is reduced graphene oxide. FIG. 1A shows the Pt nanoparticles formed at 80° C., FIG. 1B shows the Pt nanoparticles formed at 100° C., FIG. 1C shows the Pt nanoparticles formed at 150° C., FIG. 1D shows the Pt nanoparticles formed at 185° C., and FIG. 1E shows the Pt nanoparticles formed at 210° C. Within each of the figures is shown the particles at different scales, 100 nm, 50 nm, and 10 nm.

As shown in FIG. 1A, the nanocrystals obtained at 80° C. can exhibit irregular shapes including spheric, elliptic, linear, and other unnamed shapes. The sample at this temperature may not evenly deposit on the graphene oxide and can agglomerate. It is clear, however, that irregular spheres were predominant. As the synthetic temperature increased, such as about 100° C. (as shown in FIG. 1B), the shapes of nanocrystals are spheric and elliptic, and more nanocrystals deposited on graphene oxide. FIG. 1C shows the shapes of nanocrystals becoming nanocube, tetrahedron, and nanorods at 150° C. High yields of nanocubes on reduced graphene oxide appears increased at 185° C. as shown in FIG. 1D. FIG. 1E indicates that the morphology of samples synthesized at 210° C. may not keep one domain shape. For example, nanocube shape can change to various shapes compared to FIG. 1D.

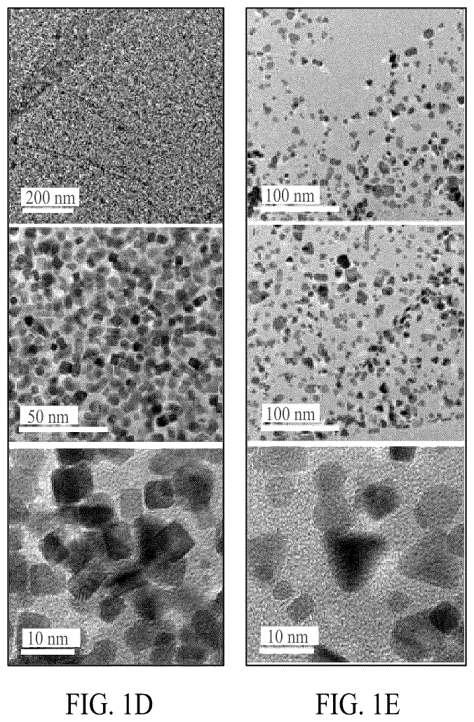

FIGS. 2A-2D show exemplary, but non-limiting, TEM images of example carbon-supported Pt nanoparticles formed during the multi-step heating process at different temperatures. Here, FIGS. 2A-2C show that the nanoparticles exhibit tetrahedron shapes from different synthesized samples via multi-step heating process, indicating the high reproducibility of the method. Given the projection of tetrahedron in TEM, FIG. 2D also includes other orientations of tetrahedron on reduced graphene oxide unlike cube which has one projection in TEM.

Table 1 shows a summary of typical results for the formation of the carbon-supported Pt nanocatalysts formed. The materials used for the formation included Pt(acac)₂ as the Pt metal source, reduced graphene oxide as the carbon source, formic acid as the acid/additive, and ethylene glycol as solvent. Samples 1 and 2 were formed according to Example 3 synthesis of Pt irregular spheres at the conditions shown in Table 1, Sample 3 was formed according to Example 1 synthesis of Pt tetrahedra at the conditions shown in Table 1, and Samples 4 and 5 were formed according to Example 2 at the conditions shown in Table 1. Samples 1, 2, 4, and 5 were formed using the one-step heating process and Sample 3 was formed using the multi-step heating process. The results were made based on visual observation of the TEM.

| | Temperature, | Time, | |
|---|---|---|---|
| Sample | ° C. | h | Selected Results |
| Sample | 80 | 48 | Irregular sphere (>95%); small amount of |
| 1 | | | cubes/tetrahedra |
| Sample | 100 | 24 | Irregular sphere (about 85%); small amount of |
| 2 | | | cubes/tetrahedra but increased relative to Sample 1 |
| Sample | 80, | 6, 24 | Tetrahedra/triangle (about 60%); cube (about 30%); |
| 3 | then 130, | 24 | small amount of irregular sphere |
| | then 210 | | |
| Sample | 185 | 24 | Cube (about 70%); small amount of irregular spheres and |
| 4 | | | tetrahedra/triangle and the amount of irregular spheres |
| | | | are less than Sample 3 |
| Sample | 210 | 24 | Mixture of irregular sphere, tetrahedron, nanocube, and |
| 5 | | | nanorods |

Overall, the data shown in Table 1 indicates that the morphology can be controlled by adjusting the temperature of the heating, the heating process (one-step versus multi-step), or combinations thereof. For example, Samples 1 and 2 show that temperatures of about 100° C. or less lead to the formation of Pt nanocrystals having mostly irregular sphere shape (Sample 1: >95% at about 80° C. for 48 hours; and Sample 2: about 85% at about 100° C. for 24 hours). The higher temperature of about 100° C. can lead to increased formation of Pt cubes and Pt tetrahedra/triangle, but still at very small amounts relative to the amount of Pt irregular spheres. Sample 3 indicates that the multi-step heating process described herein can be utilized to form carbon-supported Pt nanocrystals where the Pt nanocrystals are mostly tetrahedra/triangle-shaped, with small amounts of cube and irregular sphere. Sample 4 indicates that the higher temperature of 185° C. can be used to form carbon-supported Pt nanocrystals where the Pt nanocrystals are mostly cubes, with small amounts of cube and irregular sphere. Relative to Sample 3, the amount of irregular spheres were determined to be much less. Sample 5 indicates that a one-step heating process at 210° C. for 24 hours can form a mixture of various morphologies of Pt nanocrystals.

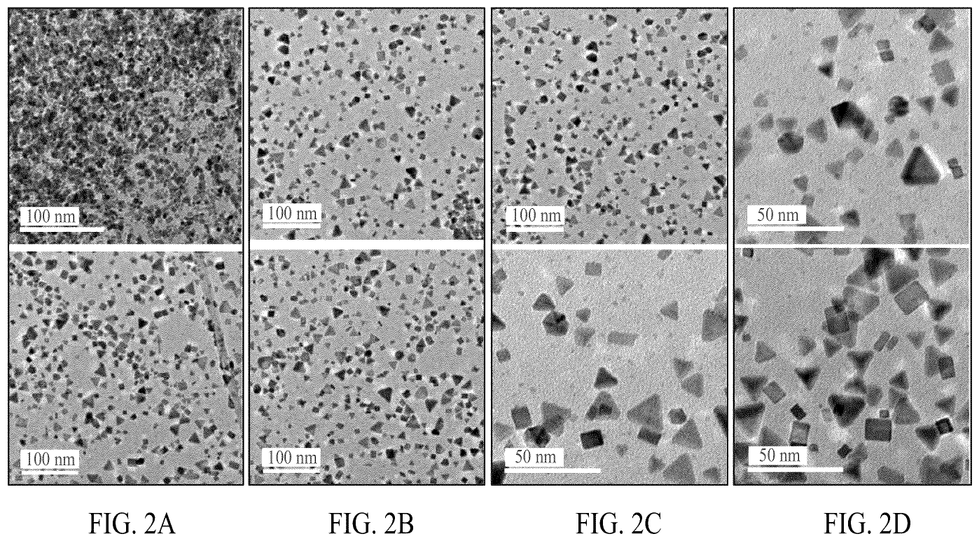

FIG. 3 shows exemplary, but non-limiting, XRD patterns of example carbon-supported Pt nanoparticles synthesized at various temperatures—80° C., 100° C., 150° C., and 210° C. The dashed circles on the XRD spectra (middle panel of FIG. 1C) indicate the graphene oxide. It should be notes that each of the carbon-supported Pt nanoparticles included the graphene oxide, but the graphene oxide may have not appeared in the XRD spectra.

The XRD spectra shown in FIG. 3 indicates that, although nanocrystals can be obtained at different temperatures, the nanoparticles still show similar crystal structures as polycrystalline Pt. In theory, well-oriented cubes or tetrahedrons can show different dominant crystal facets in XRD. However, the nanocrystals are chemically bonded to graphene oxide, which can inhibit the facet dominant orientation and the XRD may not show differences between samples.

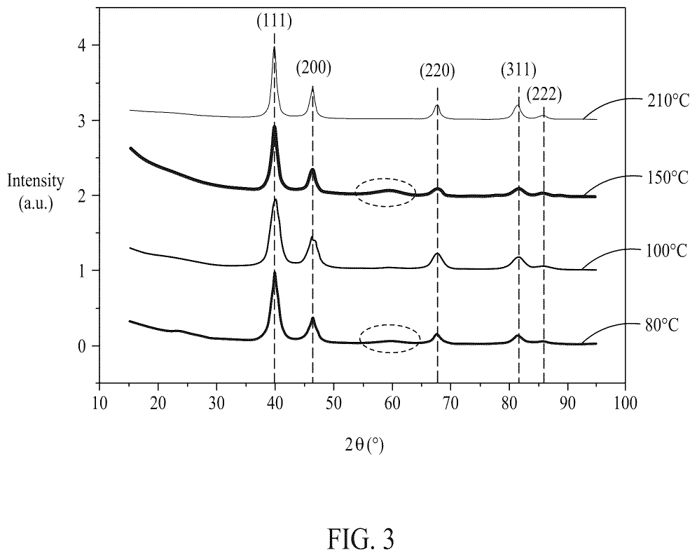

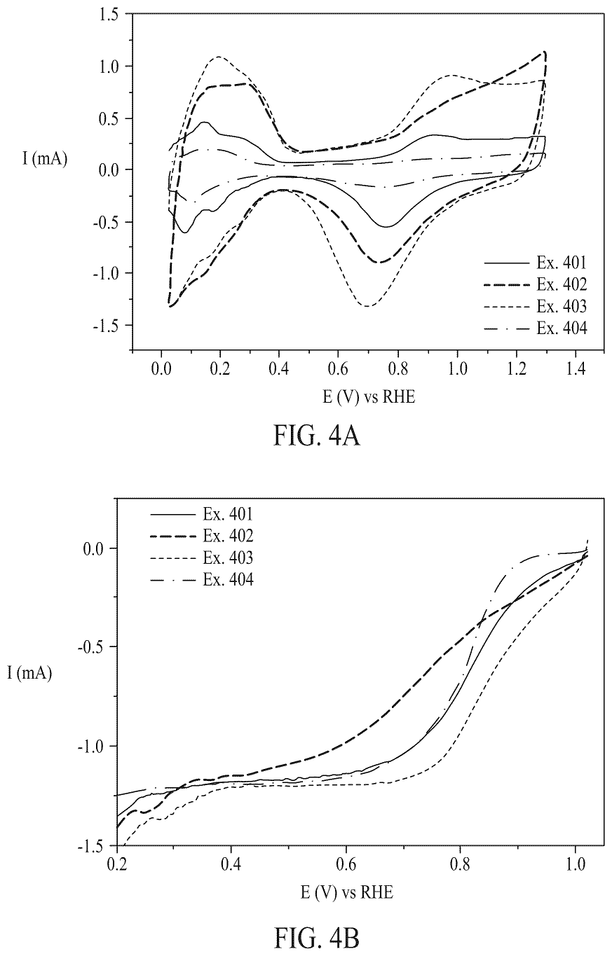

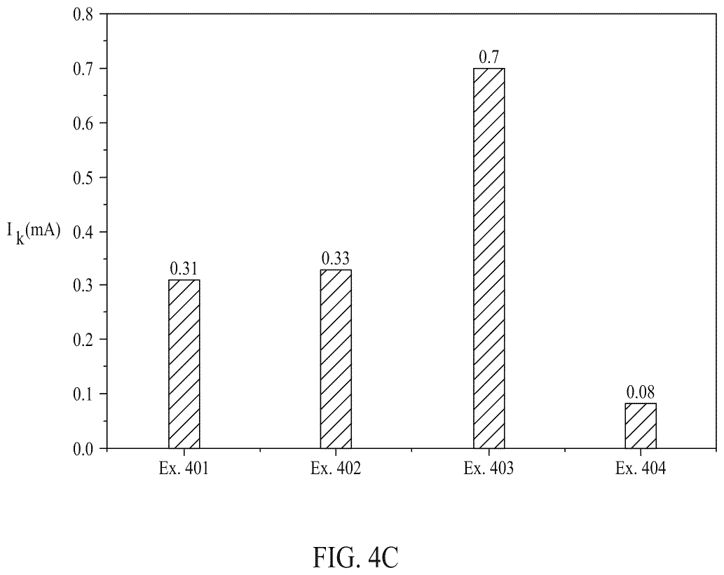

FIGS. 4A-4C show electrochemical measurements of example Pt nanocubes on reduced graphene oxide (rGO). Specifically, FIG. 4A shows exemplary, but non-limiting, cyclic voltammetry (CV) curves of example Pt nanocubes on reduced graphene oxide (rGO), FIG. 4B shows exemplary, but non-limiting, linear sweep voltammetry (LSV) curves of example Pt nanocubes on rGO, and FIG. 4C shows exemplary, but non-limiting, kinetic current data for example Pt nanocubes on rGO. For each of FIGS. 4A-4C, Examples 401 and 403 are 10 μL and 20 μL, respectively, of the Pt nanocube-rGO catalyst ink slurry on the GCE surface that were subjected to a heat treatment in air for about 24 hours to remove ethylene glycol. Example 402 is 20 μL, respectively, of the Pt nanocube-rGO catalyst ink slurry on the GCE surface that was not subjected to heat treatment. Example 404 is the commercial platinum on carbon catalyst (Pt/C, 20 wt %) and was used as a comparative example.

FIG. 4A shows CVs of the nanocube on graphene oxide at 185° C. As indicated in FIG. 4A, the sample after surface cleaning, the electrochemically active surface area (ECSA) reflected by hydrogen deposition grows. The ORR catalytic performance by polarization curves in FIG. 4B indicate that aspects described herein perform better than commercial Pt/C. The kinetic currents of the samples also corroborate this observation in FIG. 4C.

At low reaction temperatures, the Pt nanoparticles tend to be spherical in shape (irregular spheres), such as those formed at about 80° C. or about 100° C. When the reaction temperature reached approximately 130° C., the shape of the Pt nanoparticles tended to be a mixture of tetrahedra Pt nanoparticles. The multi-step process can efficiently increase the yield of tetrahedron. At higher temperatures, such as about 185° C. or more, uniform nanocube Pt nanoparticles can be formed. Overall, the results indicate that the morphology can be controlled by adjusting the temperature of the heating, the heating process (one-step versus multi-step), or combinations thereof.

Aspects of the present disclosure generally relate to processes for forming carbon-supported platinum nanocrystals. Conventional catalysts employed in fuel cell cathode electrodes face a ubiquitous issue: their performance rapidly declines after long-term durability tests. This decline is partially attributable to the carbon supports, from which catalysts can easily detach due to weak physical interactions. To address this issue and improve catalyst durability, the inventors have found a process to directly grow catalysts onto carbon supports. Concurrently, the inventors also found processes that can enable the growth of different Pt morphologies (which relates to catalyst activity) on the carbon support. As a result, and in some aspects, the inventors discovered a solvothermal-based synthetic system to synthesize various Pt nanostructures on a graphene derivative (for example, graphene oxide or reduced graphene oxide), in which the Pt nanostructures are chemically bonded to carbon. In some aspects, the only parameter to be adjusted can be the temperature, potentially simplifying future manufacturing processes. Processes described herein enable the synthesis of spherical, cubic, tetrahedral, and rod nanostructures on carbon supports such as reduced graphene oxide. As described herein, the catalytic performance of the nanocube-rGO in ORR is superior to that of commercial Pt/C. Overall, processes described herein can provide an effective strategy for the rational design of Pt-rGO nanostructures that can be used in, for example, energy conversion technologies.

### ASPECTS LISTING

The present disclosure provides, among others, the following aspects, each of which can be considered as optionally including any alternate aspects:

Clause A1. A process for forming a carbon-supported platinum catalyst, the process comprising:
forming a mixture comprising a platinum metal source, a carbon source, an acid, and a solvent; and
heating the mixture at a temperature that is from about 80° C. to about 250° C. to form a carbon-supported platinum nanocatalyst, the carbon-supported platinum nanocatalyst comprising platinum nanoparticles chemically bonded to a carbon support.

Clause A2. The process of Clause A1, wherein the mixture is free of a surfactant, a ligand, or combinations thereof, the surfactant and ligand being different from the platinum metal source, the carbon source, the acid, the solvent, or component thereof.

Clause A3. The process of Clause A1 or Clause A2, wherein the heating the mixture is performed by a one-step heating process comprising:
heating at a selected temperature or temperature range for a selected period.

Clause A4. The process of Clause A3, wherein:
the heating the mixture is performed by the one-step heating process comprising heating at a temperature that is from about 150° C. to about 210° C.; and
the carbon-supported platinum nanocatalyst comprises platinum nanocubes chemically bonded to the carbon support.

Clause A5. The process of Clause A3, wherein:
the heating the mixture is performed by the one-step heating process comprising heating at a temperature that is from about 80° C. to about 120° C.; and
the carbon-supported platinum nanocatalyst comprises platinum irregular nanospheres chemically bonded to the carbon support.

Clause A6. The process of any one of Clauses A1-A5, wherein the heating the mixture is performed by a multi-step heating process comprising:
heating the mixture at a first temperature or a first temperature range for a first period; then
heating the mixture at a second temperature or a second temperature range for a second period; and then
heating the mixture at a third temperature or a third temperature range for a third period, wherein at least two of the first temperature or range, the second temperature or range, and the third temperature or range are different.

Clause A7. The process of Clause A6, wherein:

the first temperature or first temperature range is from 50° C. to less than 110° C.;
the second temperature or second temperature range is from 110° C. to less than 170° C.;
the third temperature or third temperature range is from 170° C. to 250° C. or less; and
the carbon-supported platinum nanocatalyst comprises platinum tetrahedra chemically bonded to the carbon support.

Clause A8. The process of Clause A6, wherein:
the first temperature or first temperature range is from about 80° C. to about 100° C.;
the second temperature or second temperature range is from about 130° C. to about 150° C.; and
the third temperature or third temperature range is from about 190° C. to about 210° C.

Clause A9. The process of any one of Clauses A1-A8, wherein the acid comprises an inorganic acid, an organic acid, or combinations thereof.

Clause A10. The process of Clause A9, wherein:
when the acid comprises an inorganic acid, the inorganic acid comprises sulfuric acid, phosphoric acid, nitric acid, perchloric acid, hydrochloric acid, or combinations thereof;
when the acid comprises an organic acid, the organic acid comprises formic acid, acetic acid, carbonic acid, propionic acid, or combinations thereof, or
combinations thereof.

Clause A11. The process of any one of Clauses A1-A10, wherein the carbon source comprises a structure having graphitic bonds partially incorporating one or more heteroatoms.

Clause A12. The process of Clause A11, wherein the one or more heteroatoms comprises oxygen.

Clause A13. The process of Clause A11 or Clause A12, wherein the structure having graphitic bonds partially incorporating one or more heteroatoms comprises a nanotube, nanobud, fullerene, nano-peapod, endofullerene, nano-onion, graphene oxide, reduced graphene oxide, lacey carbon, or combinations thereof.

Clause A14. The process of any one of Clauses A1-A13, wherein the carbon source comprises a graphene derivative selected from the group consisting of graphene oxide, reduced graphene oxide, or combinations thereof.

Clause A15. The process of any one of Clauses A1-A14, wherein the solvent comprises a glycol.

Clause B1. A process for forming platinum nanocrystals of a selected morphology on a carbon support, the process comprising:
forming a mixture comprising a platinum metal source, a carbon source, an acid, and a solvent; and
heating the mixture at a temperature within a single temperature range inclusive for a selected period of time to form a carbon-supported platinum nanocatalyst, wherein:
   the carbon-supported platinum nanocatalyst comprises platinum nanocrystals chemically bonded to a carbon support; and
   the platinum nanocrystals are in the form of nanocubes or irregular nanospheres.

Clause B2. The process of Clause B1, wherein the mixture is free of a surfactant, a ligand, or combinations thereof, the surfactant and ligand being different from the platinum metal source, the carbon source, the acid, the solvent, or component thereof.

Clause B3. The process of Clause B1 or Clause B2, wherein:
the single temperature range is from about 80° C. to about 120°° C.; and
the platinum nanocrystals are in the form of the irregular nanospheres.

Clause B4. The process of any one of Clauses B1-B3, wherein:
the single temperature range is from about 150° C. to about 210° C.; and
the platinum nanocrystals are in the form of the nanocubes.

Clause B5. The process of any one of Clauses B1-B4, wherein the carbon source comprises a structure having graphitic bonds partially incorporating one or more heteroatoms, the one or more heteroatoms comprising oxygen.

Clause C1. A process for forming platinum nanocrystals on a carbon support, the process comprising:
reacting, under reaction conditions, a mixture comprising a platinum metal source, a carbon source, an acid, and a solvent to form a carbon-supported platinum nanocatalyst, wherein:
   the carbon-supported platinum nanocatalyst comprises platinum tetrahedra nanocrystals chemically bonded to the carbon support;
   the carbon source comprises a structure having graphitic bonds partially incorporating oxygen atoms; and
   the reaction conditions comprise:
      heating the mixture at a first temperature or first temperature range for a first period; then
      heating the mixture at a second temperature or second temperature range for a second period; and then
      heating the mixture at a third temperature or third temperature range for a third period, wherein at least two of the first temperature or range, the second temperature or range, and the third temperature or range are different.

Clause C2. The process of Clause C1, wherein the mixture is free of a surfactant, a ligand, or combinations thereof, the surfactant and ligand being different from the platinum metal source, the carbon source, the acid, the solvent, or component thereof.

Clause C3. The process of Clause C1 or Clause C2, wherein:
the first temperature or first temperature range is from about 70° C. to about 100° C.;
the second temperature or second temperature range is from about 120° C. to about 130° C.; and
the third temperature or third temperature range is from about 190° C. to about 210° C.

A process for controlling the morphology of platinum nanocrystals on a carbon support, the process comprising:
forming a mixture comprising a platinum metal source, a carbon source, an acid, and a solvent;
placing the mixture at an operating pressure; and
performing a heating process on the mixture, the heating process comprising, consisting essentially of, or consisting of:
   heating the mixture at a temperature within a single temperature range of about 80° C. to about 120° C. to form carbon-supported platinum nanocrystals comprising platinum irregular nanospheres chemically bonded to the carbon support; or
   heating the mixture at a temperature within a single temperature range of about 150° C. to about 210° C. to form carbon-supported platinum nanocrystals comprising platinum nanocubes chemically bonded to the carbon support; or
   heating the mixture by a multi-step heating process comprising:
      heating the mixture at a first temperature that is from 50° C. to less than 110° C.; then
      heating the mixture at a second temperature that is from 110° C. to less than 170° C.; and then
      heating the mixture at a third temperature that is from 170° C. to 250° C. or less to form carbon-supported platinum nanocrystals comprising platinum tetrahedra chemically bonded to the carbon support.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, element, or elements and vice versa, e.g., the terms “comprising,” “consisting essentially of,” “consisting of” also include the product of the combinations of elements listed after the term.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa, e.g., the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

As used herein, the indefinite article “a” or “an” shall mean “at least one” unless specified to the contrary or the context clearly indicates otherwise. For example, aspects comprising “a carbon source” include aspects comprising one, two, or more carbon sources, unless specified to the contrary or the context clearly indicates only one carbon source is included.

While the foregoing is directed to aspects of the present disclosure, other and further aspects of the disclosure may be devised without departing from the basic scope thereof, and the scope thereof is determined by the claims that follow.

What is claimed is:

1. A process for forming a carbon-supported platinum catalyst, the process comprising:
forming a mixture comprising a platinum metal source, a carbon source, an acid, and a solvent; and
heating the mixture at a temperature that is from about 80° C. to about 250° C. to form a carbon-supported platinum nanocatalyst, the carbon-supported platinum nanocatalyst comprising platinum nanoparticles chemically bonded to a carbon support.

2. The process of claim 1, wherein the heating the mixture is performed by a one-step heating process comprising:
heating at a selected temperature or temperature range for a selected period.

3. The process of claim 2, wherein:
the heating the mixture is performed by the one-step heating process comprising heating at a temperature that is from about 150° C. to about 210° C.; and
the carbon-supported platinum nanocatalyst comprises platinum nanocubes chemically bonded to the carbon support.

4. The process of claim 2, wherein:
the heating the mixture is performed by the one-step heating process comprising heating at a temperature that is from about 80° C. to about 120° C.; and
the carbon-supported platinum nanocatalyst comprises platinum irregular nanospheres chemically bonded to the carbon support.

5. The process of claim 1, wherein the heating the mixture is performed by a multi-step heating process comprising:
heating the mixture at a first temperature or a first temperature range for a first period; then
heating the mixture at a second temperature or a second temperature range for a second period; and then
heating the mixture at a third temperature or a third temperature range for a third period, wherein at least two of the first temperature or range, the second temperature or range, and the third temperature or range are different.

6. The process of claim 5, wherein:
the first temperature or first temperature range is from 50° C. to less than 110° C.;
the second temperature or second temperature range is from 110° C. to less than 170° C.;
the third temperature or third temperature range is from 170° C. to 250° C. or less; and
the carbon-supported platinum nanocatalyst comprises platinum tetrahedra chemically bonded to the carbon support.

7. The process of claim 5, wherein:
the first temperature or first temperature range is from about 80° C. to about 100° C.;
the second temperature or second temperature range is from about 130° C. to about 150° C.; and
the third temperature or third temperature range is from about 190° C. to about 210° C.

8. The process of claim 1, wherein the acid comprises an inorganic acid, an organic acid, or combinations thereof.

9. The process of claim 8, wherein:
when the acid comprises an inorganic acid, the inorganic acid comprises sulfuric acid, phosphoric acid, nitric acid, perchloric acid, hydrochloric acid, or combinations thereof;
when the acid comprises an organic acid, the organic acid comprises formic acid, acetic acid, carbonic acid, propionic acid, or combinations thereof; or
combinations thereof.

10. The process of claim 1, wherein the carbon source comprises a structure having graphitic bonds partially incorporating one or more heteroatoms.

11. The process of claim 10, wherein the one or more heteroatoms comprises oxygen.

12. The process of claim 10, wherein the structure having graphitic bonds partially incorporating one or more heteroatoms comprises a nanotube, nanobud, fullerene, nano-peapod, endofullerene, nano-onion, graphene oxide, reduced graphene oxide, lacey carbon, or combinations thereof.

13. The process of claim 1, wherein the carbon source comprises a graphene derivative selected from the group consisting of graphene oxide, reduced graphene oxide, or combinations thereof.

14. The process of claim 1, wherein the solvent comprises a glycol.

15. A process for forming platinum nanocrystals of a selected morphology on a carbon support, the process comprising:
forming a mixture comprising a platinum metal source, a carbon source, an acid, and a solvent; and
heating the mixture at a temperature within a single temperature range inclusive for a selected period of time to form a carbon-supported platinum nanocatalyst, wherein:
the carbon-supported platinum nanocatalyst comprises platinum nanocrystals chemically bonded to a carbon support; and
the platinum nanocrystals are in the form of nanocubes or irregular nanospheres.

16. The process of claim 15, wherein:
the single temperature range is from about 80° C. to about 120° C.; and
the platinum nanocrystals are in the form of the irregular nanospheres.

17. The process of claim 15, wherein:
the single temperature range is from about 150° C. to about 210° C.; and
the platinum nanocrystals are in the form of the nanocubes.

18. The process of claim 15, wherein the carbon source comprises a structure having graphitic bonds partially incorporating one or more heteroatoms, the one or more heteroatoms comprising oxygen.

19. A process for forming platinum nanocrystals on a carbon support, the process comprising:
reacting, under reaction conditions, a mixture comprising a platinum metal source, a carbon source, an acid, and a solvent to form a carbon-supported platinum nanocatalyst, wherein:
the carbon-supported platinum nanocatalyst comprises platinum tetrahedra nanocrystals chemically bonded to the carbon support;
the carbon source comprises a structure having graphitic bonds partially incorporating oxygen atoms; and
the reaction conditions comprise:
heating the mixture at a first temperature or first temperature range for a first period; then
heating the mixture at a second temperature or second temperature range for a second period; and then
heating the mixture at a third temperature or third temperature range for a third period, wherein at least two of the first temperature or range, the second temperature or range, and the third temperature or range are different.

20. The process of claim 19, wherein:
the first temperature or first temperature range is from about 70° C. to about 100° C.;
the second temperature or second temperature range is from about 120° C. to about 130° C.; and
the third temperature or third temperature range is from about 190° C. to about 210° C.
